(19) United States
(12) Patent Application Publication
(10) Pub. No.: US 2013/0314914 A1
(43) Pub. Date: Nov. 28, 2013

(54) OPTICAL SEMICONDUCTOR LIGHTING APPARATUS

(71) Applicant: POSCO LED COMPANY LTD., Seongnam-si (KR)

(72) Inventors: Dong Soo KIM, Seongnam-si (KR); Seok Jin Kang, Seongnam-si (KR); Yoon Gil Jang, Seongnam-si (KR); Su Woon Lee, Seongnam-si (KR); Dong Hee Kim, Seongnam-si (KR)

(73) Assignee: POSCO LED COMPANY LTD., Seongnam-si (KR)

(21) Appl. No.: 13/683,414

(22) Filed: Nov. 21, 2012

(30) Foreign Application Priority Data
May 23, 2012 (KR) 10-2012-0054718
May 23, 2012 (KR) 10-2012-0054720

(51) Int. Cl. F21V 29/00; F21V 15/01

(52) U.S. Cl. CPC F21V 29/002; F21V 29/004; F21V 29/006; F21V 15/01
USPC 362/235; 362/373

(57) ABSTRACT

An optical semiconductor lighting apparatus includes: a light emitting module including one or more semiconductor optical devices; a switching mode power supply (SMPS) connected to the light emitting module; a housing disposed to be adjacent to the light emitting module, in which the housing has both ends opened and accommodates the SMPS; a first heat dissipation unit disposed at an inner side of the housing; and a second heat dissipation unit disposed radially at an outer side of the housing and formed from an outer side of one end portion of the housing to the edge of the light emitting module. The first heat dissipation unit includes a plurality of heat dissipation plates through which the heat pipe penetrates, and a plurality of vent portions formed on the heat dissipation plates.

### CROSS-REFERENCE TO RELATED APPLICATIONS

This application claims priority from and the benefit of Korean Patent Application No. 10-2012-0054718, filed on May 23, 2012, and Korean Patent Application No. 10-2012-0054720, filed on May 23, 2012, which are hereby incorporated by reference for all purposes as if fully set forth herein.

### BACKGROUND

1. Field

The present invention relates to an optical semiconductor lighting apparatus.

2. Discussion of the Background

Compared with incandescent light and fluorescent light, optical semiconductors, such as light emitting diodes (LEDs) or laser diodes (LDs), consume low power, have a long lifespan, and have high durability and high brightness. Due to these advantages, optical semiconductors have recently attracted much attention as one of components for lighting.

Typically, in the lighting apparatuses using such optical semiconductor, heat is inevitably generated from the optical semiconductors. Therefore, it is necessary to install heat sinks at heat generation sites so as to discharge the generated heat to the exterior.

A heat sink dissipates heat transmitted from an optical semiconductor to the exterior through heat exchange with outside air. As a heat transmission area of the heat sink is increased, a contact area with outside air is increased and heat dissipation performance is improved.

However, in a situation that a heat sink needs to be downsized according to the recent tendency of integration and reduction in size of electronic components or semiconductor optical devices, it is difficult to infinitely increase a heat transmission area only to improve heat dissipation performance.

Meanwhile, lighting apparatuses using optical semiconductors have been utilized in various fields. In particular, lighting apparatuses tend to be utilized as factory light or working light in factories or industrial settings.

In many cases, lighting apparatuses used as factory light or working light are installed in sites where heat generation is severe due to environmental characteristics. Heat generated from optical semiconductors themselves and heat generated from facilities near the lighting apparatuses may cause malfunction of the lighting apparatuses.

In order to avoid such problems, a lighting apparatus used as factory light or working light includes a heat sink and a fan for forced cooling. However, the installation of the lighting apparatus having even a fan in a small and medium-sized workplace inevitably incurs additional energy cost due to additional power consumption, which is undesirable in terms of economic efficiency.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

An aspect of the present invention is directed to an optical semiconductor lighting apparatus capable of enhancing heat dissipation efficiency by inducing a turbulent flow while extending air contact time.

Another aspect of the present invention is directed to an optical semiconductor lighting apparatus capable of enhancing heat dissipation efficiency by inducing air circulation in the exterior and interior thereof.

According to an embodiment of the present invention, an optical semiconductor lighting apparatus includes: a light emitting module including one or more semiconductor optical devices; one or more heat pipes provided in the light emitting module; a plurality of heat dissipation plates disposed to be spaced apart from the light emitting module, wherein the heat pipe penetrates the plurality of heat dissipation plates; and a vent portion formed on each of the heat dissipation plates and forming a circulation path of air flowing on one surface and the other surface of each of the heat dissipation plates.

The vent portion may include: a plurality of vent holes formed to penetrate the heat dissipation plates; and a plurality of vent guides extending from one side of each of the vent holes.

The vent holes may be disposed in a plurality of rows and columns on the heat dissipation plates. The vent guides in odd-numbered rows or odd-numbered columns among the plurality of rows or columns may protrude from one surface of each of the heat dissipation plates. The vent guides in even-numbered rows or even-numbered columns among the plurality of rows or columns may protrude from the other surface of each of the heat dissipation plates.

The optical semiconductor lighting apparatus may further include: vent cutout portions formed at both edges of the heat dissipation plates on virtual lines extending from the plurality of rows or columns; and auxiliary vent guides extending from one side of each of the vent cutout portions and having the same shape as that of the vent guides.

The auxiliary vent guides may protrude from the heat dissipation plates in the same direction as that of the vent guides in a first even-numbered row or in a first even-numbered column among the plurality of rows or columns.

The vent holes disposed at equal intervals in the odd-numbered rows or the odd-numbered columns among the plurality of rows or columns may be disposed at intersection points of virtual straight lines extending slopingly from the vent hole and vent holes adjacent to the vent holes, which are disposed at equal intervals in the even-numbered rows or the even-numbered columns among the plurality of rows or columns, to the odd-numbered rows or odd-numbered columns adjacent to the even-numbered rows or the even-numbered columns.

The vent guide may include: a first piece extending from one side of the is vent hole formed on the heat dissipation plate; and a second piece formed by bending an end portion of the first piece.

The second piece may be parallel to the heat dissipation plate.

The second piece may be sloped in a direction farther away from the heat dissipation plate.

The second piece may be sloped in a direction closer to the heat dissipation plate.

A distance from an end portion of the first piece to an end portion of the second piece may be greater than a distance from the heat dissipation plate to the end portion of the first piece.

The end portion of the second piece may be disposed on a virtual straight line extending from the other side of the vent hole in a direction perpendicular to the heat dissipation plate.

A virtual straight line extending from the end portion of the second piece in a direction perpendicular to the heat dissipation plate may pass through an outer side of the other edge of the vent hole.

A virtual straight line extending from the end portion of the second piece in a direction perpendicular to the heat dissipation plate may pass through an inner side of the other edge of the vent hole.

The light emitting module may include a heat sink base having one surface to which the heat pipe is coupled and the other surface on which the semiconductor optical device is disposed.

The heat sink base may include one or more mounting recesses to which one side of the heat pipe is fixed.

The heat sink base may include one or more fixing holes into which one side of the heat pipe is inserted.

The optical semiconductor lighting apparatus may further includes a plurality of heat dissipation fins protruding from one surface of the heat sink base in a direction perpendicular to or parallel to a direction in which the heat pipe is formed.

The heat pipe may include: a first pipe coupled to one surface of the light emitting module; and a second pipe formed by bending an end portion of the first pipe.

The heat pipe may include a third pipe formed by bending an end portion of the second pipe.

According to another embodiment of the present invention, an optical semiconductor lighting apparatus includes: a light emitting module including one or more semiconductor optical devices; a switching mode power supply (SMPS) connected to the light emitting module; a housing disposed to be adjacent to the light emitting module, wherein the housing has both ends opened and accommodates the SMPS; a first heat dissipation unit disposed at an inner side of the housing; and a second heat dissipation unit disposed radially at an outer side of the housing and formed from an outer side of one end portion of the housing to the edge of the light emitting module.

The optical semiconductor lighting apparatus may further include a vent hole communicating with the interior of the housing at the center of the light emitting module.

The housing may include: a first member covering one side of the SMPS in a length direction of the SMPS; and a second member covering the other side of the SMPS in the length direction of the SMPS and detachably coupled to the first member.

The first heat dissipation unit may further include a fixed panel having both edges slidably coupled to an inner surface of the housing, the SMPS being disposed on the fixed panel, and the SMPS and the light emitting module may be spaced apart is from each other.

The housing may further include movement grooves formed on mutually facing surfaces in the interior of the housing, both edges of the fixed panel being coupled to the movement grooves, and the housing may be attached or detached in the length direction of the SMPS.

The fixed panel may further include a plurality of heat dissipation fins protruding from a surface opposed to the surface on which the SMPS is disposed, in a direction in which the SMPS is coupled.

A space between the mutually adjacent heat dissipation fins may communicate with the light emitting module.

The second heat dissipation unit may include one or more vent slits formed to penetrate an edge of the light emitting module.

The second heat dissipation unit may include a heat pipe assembly disposed on an outer surface of the housing and communicating with the light emitting module.

The second heat dissipation unit may include a top air guide detachably coupled to an upper end portion of the housing and communicating with the light emitting module.

The heat pipe assembly may include: a plurality of heat dissipation thin plates disposed radially along the outer surface of the housing; and a heat pipe penetrating the respective heat dissipation thin plates and forming an internal flow path.

The optical semiconductor lighting apparatus may further include a cover casing disposed in the outer side of the heat dissipation thin plates and having both ends opened.

The heat pipe assembly may further include an interval piece bent from an upper or lower end portion of the heat dissipation thin plate and extending up to an upper or lower end portion of a heat dissipation thin plate adjacent to the heat dissipation thin plate.

The heat pipe assembly may further include one or more auxiliary vent slots penetrating the respective heat dissipation thin plates.

The top air guide may include: a cover piece covering an upper end portion of the housing; and a coupling partition extending from the cover piece and disposed in contact with an outer surface of an upper end portion of the housing.

The top air guide may further include a plurality of cover vent slits penetrating the cover piece such that the cover vent slits correspond to an inner space formed by the coupling partition.

The top air guide may further include a plurality of guide ribs extending radially to a lower surface of the cover piece along an outer surface of the coupling partition.

According to another embodiment of the present invention, an optical semiconductor lighting apparatus includes: a light emitting module including one or more semiconductor optical devices; a switching mode power supply (SMPS) connected to the light emitting module; a housing disposed to be adjacent to the light emitting module and covering the SMPS; a partition unit provided within the housing; and an optical member corresponding to the semiconductor optical devices and facing the light emitting module.

The partition unit may include: a fixed panel on which the SMPS is disposed; and a plurality of heat dissipation fins protruding from a surface opposite to the surface on which the SMPS is disposed.

The housing may include: a first member covering one side of the SMPS in a length direction of the SMPS; and a second member detachably coupled to the first member and covering the heat dissipation unit coupled to the SMPS.

The partition unit may be an insulating film wound several times along the outer surface of the SMPS.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a lateral conceptual view illustrating an overall configuration of an optical semiconductor lighting apparatus according to an embodiment of the present invention.

FIGS. 2 and 3 are perspective views illustrating a scheme of coupling a light emitting module and a heat pipe as major parts of the present invention.

FIGS. 4 to 6 are plan conceptual views viewed from a position B of FIG. 2.

FIGS. 7 to 13 are partial sectional conceptual views illustrating a shape of a vent portion of the optical semiconductor lighting apparatus according to various embodiments of the present invention.

FIG. 14 is a perspective view illustrating a configuration of a heat dissipation plate as a major part of the optical semiconductor lighting apparatus according to an embodiment of the present invention.

FIG. 15 is a conceptual view viewed from a position C of FIG. 14.

FIGS. 16 to 21 are conceptual views illustrating arrangement of the heat dissipation plate as a major part of the optical semiconductor lighting apparatus according to various embodiments of the present invention.

FIGS. 22 and 23 are perspective views illustrating a state in which the vent portion is disposed on the heat dissipation plate as a major part of the optical semiconductor lighting apparatus according to another embodiment of the present invention.

FIG. 24 is a lateral conceptual view illustrating an external appearance of the optical semiconductor lighting apparatus according to another embodiment of the present invention.

FIG. 25 is a perspective view illustrating an external appearance of the optical semiconductor lighting apparatus according to another embodiment of the present invention.

FIG. 26 is a partial cutaway perspective view illustrating an internal structure of the optical semiconductor lighting apparatus according to another embodiment of the present invention.

FIG. 27 is a partial exploded perspective view illustrating a coupling relationship between a housing and a switching mode power supply (SMPS) as major parts of the optical semiconductor lighting apparatus according to another embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

FIG. 1 is a lateral conceptual view illustrating an overall configuration of an optical semiconductor lighting apparatus according to an embodiment of the present invention.

As illustrated in FIG. 1, an optical semiconductor lighting apparatus according to an embodiment of the present invention is configured such that a heat pipe 200 is provided in a light emitting module 100, and vent portions 500 are formed on a plurality of heat dissipation plates 300 disposed in the heat pipe 200.

The light emitting module 100 includes one or more semiconductor optical devices 101 driven by power. The light emitting module 100 serves as a light source.

One or more heat pipes 200 are provided in the light emitting module 100 to cool heat generated from the light emitting module 100 with latent heat of vaporization of a refrigerant filled therein.

A plurality of heat dissipation plates 300 are disposed to be spaced apart from one another in a direction in which the heat pipes 200 are formed, and are spaced apart from the light emitting module 100 by a predetermined interval h. The heat dissipation plates 300 increase a heat transmission area to cool heat generated from the light emitting module 100 together with the heat pipe 200.

The vent portions 500 are formed on the heat dissipation plats 300, respectively, and form a circulation path f of air alternately flowing along one surface and the other surface of the heat dissipation plates 300, specifically, flowing in an ‘S’-shape or a meander shape. In this manner, the vent portions 500 serve to extend air contact time and retard air flow to thereby enhance heat dissipation performance.

In addition to the foregoing embodiment, the following various embodiments can also be applied.

As described above, the light emitting module 100 serves as a light source, and includes a heat sink base 110 having one surface to which the heat pipe 200 is coupled and the other surface on which the semiconductor optical devices 101 are disposed as illustrated.

The semiconductor optical devices 101 are mounted on a PCB 120.

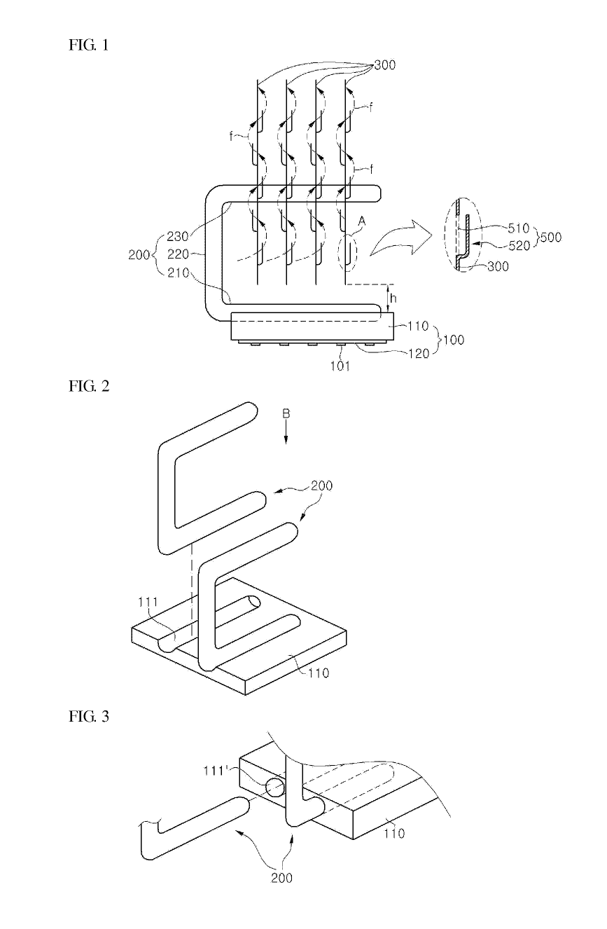

In this case, as illustrated in FIG. 2, one or more mounting recesses 111, to which one end of the heat pipe 200 is fixed, may be formed on the heat sink base 11. Alternatively, as illustrated in FIG. 3, one or more fixing holes 111′, into which one end of the heat pipe 200 is inserted, may be formed in the heat sink base 110 to allow the heat pipe 200 to be coupled to the heat sink base 110.

The heat pipe 200 serves to implement cooling performance with latent heat of vaporization of a refrigerant injected thereinto, and distilled water, methanol, ethanol, and the like, may be used as the refrigerant.

As illustrated in FIG. 4, based on the direction in which the heat pipe 200 is formed, that is, based on the mounting recess 111, the heat sink base 110 may include a plurality of heat dissipation fins 112 protruding from one surface of the heat sink base 110 such that the heat dissipation fins 112 are perpendicular to a direction in which the mounting recesses 111 are formed.

Also, as illustrated in FIG. 5, the heat sink base 110 may include a plurality of heat dissipation fins 112′ protruding from one surface of the heat sink base 110 such that the heat dissipation fins 112′ are parallel to a direction in which the heat pipe 200 is formed, that is, in a direction in which the mounting recesses 111 are formed.

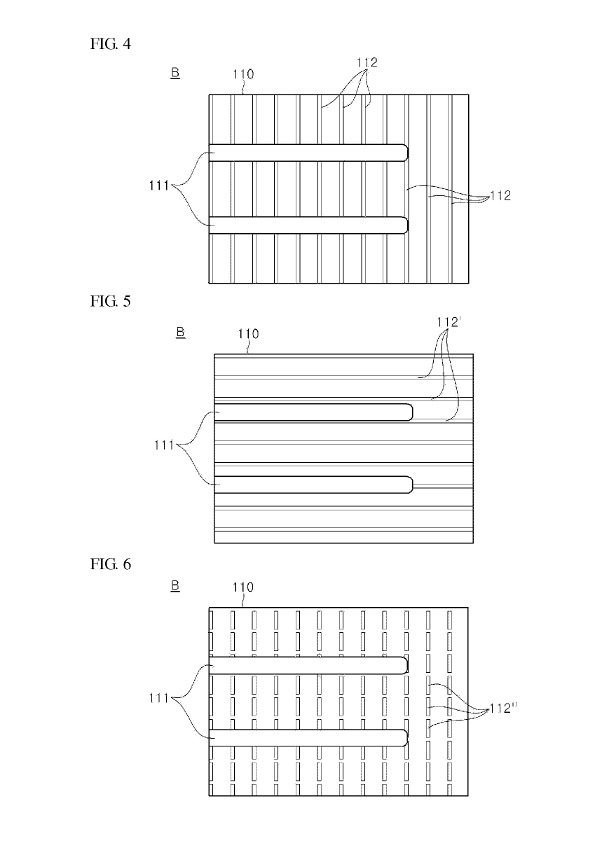

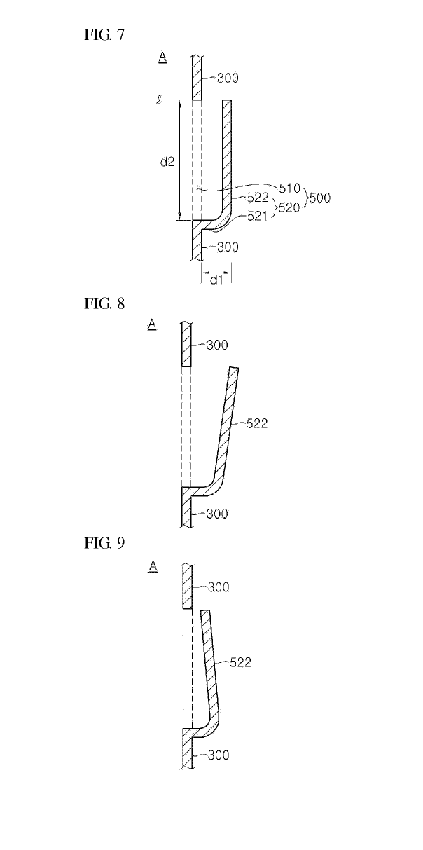

Also, as illustrated in FIG. 6, a plurality of small dissipation fins 112″ fragmented in rows and columns may be formed to be perpendicular to a direction in which the heat pipe 200 is formed, that is, in a direction in which the mounting recesses 111 are formed.

In this manner, the heat dissipation fins 112, 112′ and 112″ according to the various embodiments, as illustrated in FIGS. 4 to 6, may be applied to further enhance heat dissipation performance together with the heat pipe 200 and the heat dissipation plate 300.

On the other hand, as described above, the heat pipe 200 serves to cool heat generated from the light emitting module 100 with latent heat of vaporization, and may include a first pipe 210 coupled to one surface of the light emitting module 100 and a second pipe 220 formed by bending an end portion of the first pipe 210.

The plurality of heat dissipation plates 300 may be disposed to be spaced apart from one another in a length direction of the second pipe 220.

Also, the heat pipe 200 may include a third pipe 230 formed by bending an end portion of the second pipe 220, and the plurality of heat dissipation plates 300 may be disposed to be spaced apart from one another in a length direction of the third pipe 230.

On the other hand, as described above, the vent portion 500 serves to increase heat dissipation performance by extending air contact time and retarding air circulation, and the vent portion 500 includes a plurality of vent holes 510 penetrating the heat dissipation plates 300, and vent guides 520 extending from one side of each of the vent holes 510.

The vent guide 520 of the vent portion 500 will be described in detail with reference to FIG. 7. The vent guide 520 includes a first piece 521 extending from one side of the vent hole 510 formed in the heat dissipation plate 300, and a second piece 522 formed by bending an end portion of the first piece 521.

The second piece 522 may be parallel to the heat dissipation plate 300, and a distance d2 from the end portion of the first piece 521 to the end portion of the second piece 522 may be greater than a distance d1 from the heat dissipation plate 300 to the end portion of the first piece 521.

The formation structures and lengths of the first and second pieces 521 and 522 as described above, which allow a development flow region starting from a formation start point of each vent guide 520 to be formed at uniform intervals, are technical means for avoiding a degradation in a surface heat transmission effect due to a complete development flow region formed on the surface of the heat dissipation plates 300 when the vent guides 520 are not formed

That is, heat dissipation efficiency in a portion of the heat dissipation plate 300 through which the heat pipe 200 penetrates and a perimeter thereof is greater than that of the other portions, because a development flow region is formed in the vicinity of the heat pipe 200.

Therefore, the repeated formation structure of the vent holes 510 and the vent guides 520 repeatedly form the development flow region on the entire surface of the heat dissipation plates 300 to thereby increase heat dissipation efficiency and retard air flow along the circulation path f formed through the vent holes 510. Primary cooling can be performed by the heat pipe 200 and secondary cooling can be performed by the air flow through the repeatedly formed development flow region, that is, the vent hole 510.

In other words, when assuming a flat plate having no obstacle such as the vent guide 520, the velocity of air flow in the complete development flow region is accelerated. When the velocity of air flow is accelerated, heat dissipation efficiency is generally lowered. Thus, components such as the vent hole 510 and the vent guide 520 of the vent portion 500 as described above can slow air, thereby enhancing heat dissipation efficiency.

As a method for activating a turbulent flow of air, the second piece 522 may be sloped in a direction farther away from the heat dissipation plate 300 as illustrated in FIG. 8, or may be sloped in a direction closer to the heat dissipation plate 300 as illustrated in FIG. 9.

Also, in order to activate turbulent flow or air in various shapes, the end portion of the second piece 522 may be positioned at different levels as illustrated in FIGS. 7, 10 and 11.

That is, as illustrated in FIG. 7, the end portion of the second piece 522 may be disposed on a virtual straight line l extending from the other side of the vent hole 510 in a direction perpendicular to the heat dissipation plate 300.

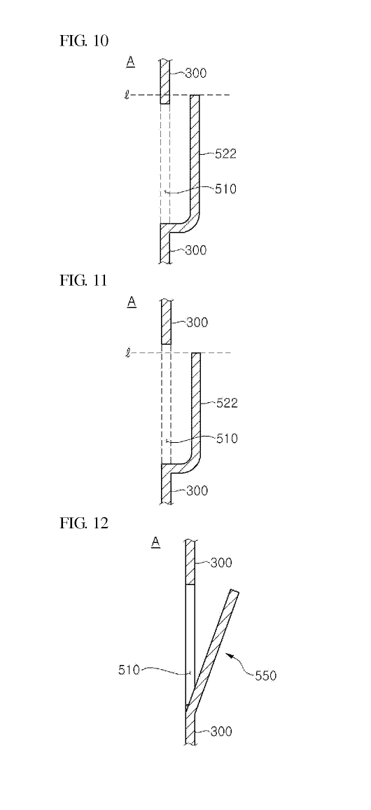

Also, as illustrated in FIG. 10, the end portion of the second piece 522 may be disposed such that the straight line l extending from the end portion of the second piece 522 in a direction perpendicular to the heat dissipation plate 300 passes through an outer side of the other edge of the vent hole 510.

Also, as illustrated in FIG. 11, the end portion of the second piece 522 may be disposed such that the straight line l extending from the end portion of the second piece 522 in a direction perpendicular to the heat dissipation plate 300 passes through an inner side of the other edge of the vent hole 510.

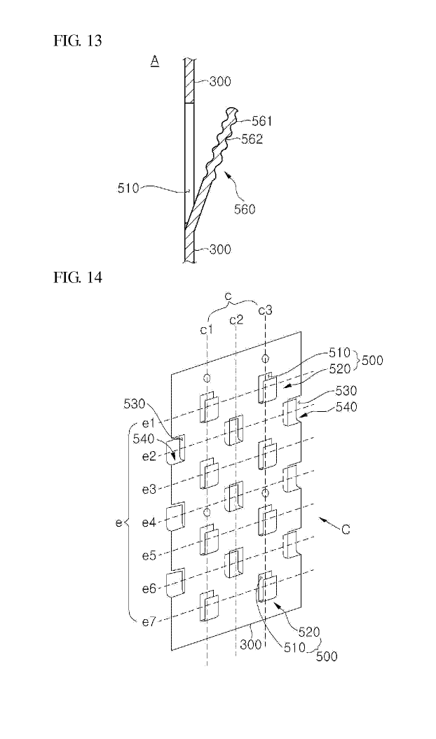

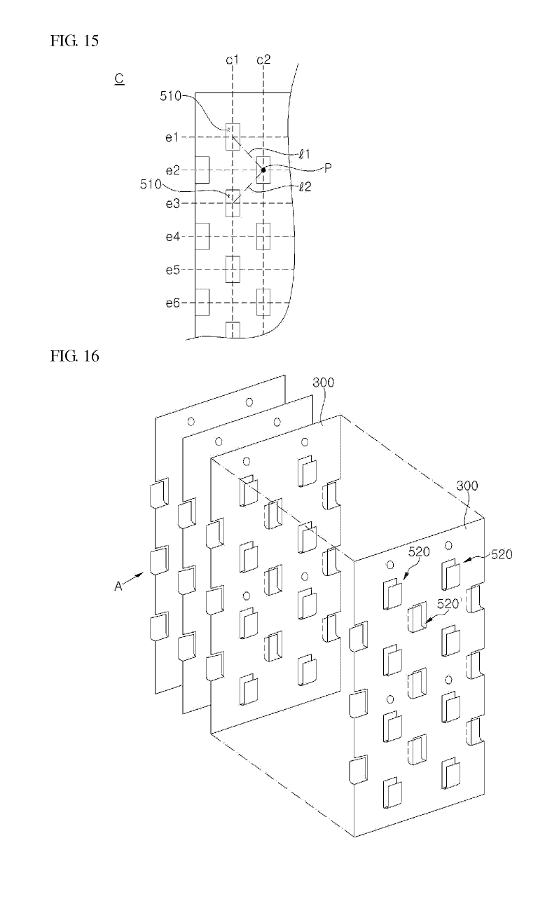

Meanwhile, besides the foregoing embodiments, the vent guide may be manufactured to have various shapes, including those of FIGS. 12 and 13.

That is, as illustrated in FIG. 12, a vent guide 550 may extend from one edge of the vent hole 510 and be sloped with respect to the heat dissipation plate 300. Alternatively, as illustrated in FIG. 13, a sloped vent guide 560 may include a pattern in which mountains 561 and valleys 562 are repeatedly formed so as to further activate a turbulent flow from each vent hole 510.

Meanwhile, the structure in which the vent hole 510 is disposed on the heat dissipation plate 300 will be described with reference to FIGS. 14 and 15.

As illustrated in FIG. 14, a plurality of vent holes 510 are disposed in rows and columns on the heat dissipation plate 300, and the vent guides 520 in odd-numbered rows e1, e3, e5 and e7 or in odd-numbered rows c1 and c3, among the plurality of rows e or columns c, protrude from one surface of the heat dissipation plate 300, and the vent guides 520 in even-numbered rows e2, e4 and e6 or in an even-numbered row c2, among the plurality of rows e or columns c, protrude from the other surface of the heat dissipation plate 300.

For reference, one surface of the heat dissipation plate 300 refers to a surface in an outward direction on the drawing, and the other surface of the heat dissipation plate 300 refers to a surface in an inward direction on the drawing.

Although not particularly illustrated, the vent holes 510 may be applied reverse to the case of FIG. 14. That is, the vent guides 520 in the odd-numbered rows e1, e3, e5, and e7 or in the odd-numbered rows c1 and c3 may protrude from the other surface of the heat dissipation plate 300, and the vent guides 520 in the even-numbered rows e2, e4, and e6 or in the even-numbered row c2 may protrude from one surface of the heat dissipation plate 300.

The arrangement structure of the vent holes 510 and the vent guides 520 aims at forming the air circulation path f (see FIG. 1) along which air alternately flows on the one surface and the other surface of the heat dissipation plate 300 in order to improve heat dissipation performance.

Also, referring to FIG. 15, the vent holes 510 disposed at equal intervals in the odd-numbered rows e1, e3, e5, and e7 or in the odd-numbered columns c1 and c3 among the plurality of rows e and columns c are disposed at points P at which virtual straight lines l1 and l2 are intersected, that is, in zigzags, to cause a turbulent flow and retard air flow in order to improve heat dissipation performance.

That is, the vent holes 510 disposed at equal intervals in the odd-numbered rows e1, e3, e5, and e7 and the odd-numbered columns c1 and c3 and the vent holes 510 disposed at equal intervals in the even-numbered rows e2, e4, and e6 or in the even-numbered column c are disposed at intersection points P of the virtual straight lines l1 and l2 extending slopingly from the respective vent holes 510 to the odd-numbered rows or odd-numbered columns adjacent to even-numbered rows or even-numbered columns.

Meanwhile, the optical semiconductor lighting apparatus according to another embodiment of the present invention may further include a vent cutout portion 530 and an auxiliary vent guide 540 in order to effectively use the entire area of the heat dissipation plate 300.

That is, the vent cutout portion 530 is formed on both edges of the heat dissipation plate 300 on the virtual straight line l extending from the plurality of rows e or columns c, and the auxiliary vent guide 540 extends from one side of the vent cutout portion 530 such that the auxiliary vent guide 540 has the same shape as that of the vent guide 520.

According to an embodiment, the auxiliary vent guide 540 may protrude from the heat dissipation plate 300 in the same direction as that of the vent guide 520 in the first even-numbered row e2 or the first even-numbered column c2 among the plurality of rows e or columns c.

Also, as illustrated in FIGS. 16 to 23, the vent guides 520 and 520′ may have various arrangement structures to form the air circulation path f through induction of a turbulent flow in order to promote the heat dissipation effect.

For reference, in FIGS. 17, 19 and 21, reference numeral 520 indicated to be dark denotes the vent guide disposed in the outward direction of the drawing, relative to reference numeral 520′ indicated to be transparent.

Also, in FIGS. 17, 19 and 21, a vertical direction of the drawing is defined as a column direction, and a row direction is defined relatively as an outward or inward direction of the drawing.

That is, as illustrated in FIGS. 16 and 17, the vent guides 520 protrude in the same direction along the certain column direction, and the vent guides 520′ protrude in the opposite direction of the vent guides 520, as described above, in a column direction adjacent to the foregoing certain column.

When the plurality of heat dissipation plates 300 with the vent guides 520 and 520′ are disposed in parallel, the structure illustrated in FIGS. 16 and 17 may be implemented.

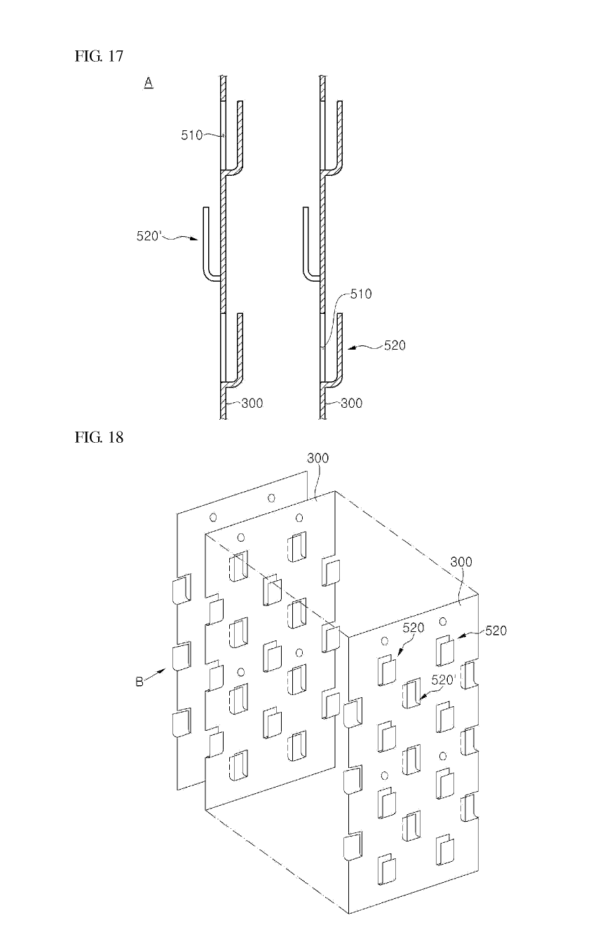

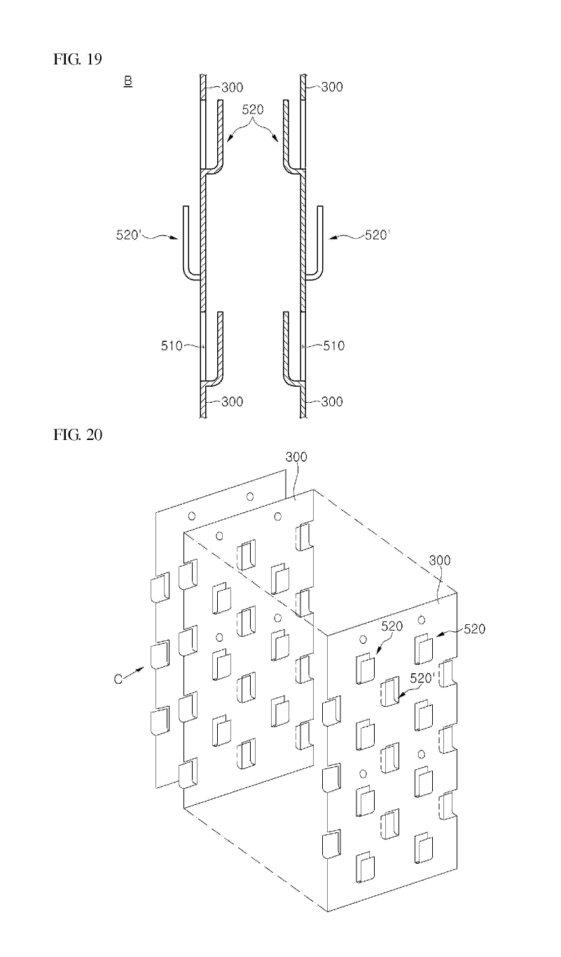

Also, in the arrangement structure of the heat dissipation plate 300 illustrated in FIGS. 18 and 19, a plurality of the patterns disposed opposed to the left heat dissipation plate 300 of FIG. 17 are arranged.

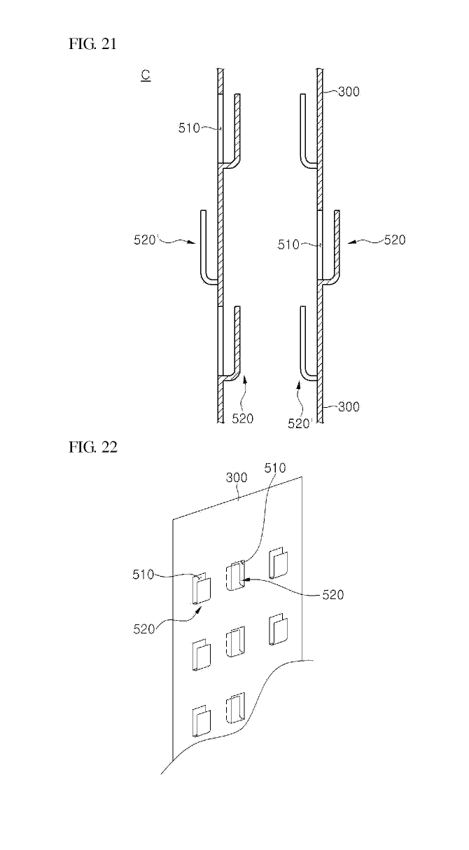

Also, in the arrangement structure of the heat dissipation plate 300 illustrated in FIGS. 20 and 21, a plurality of vent guides 520 and 520′ are disposed to protrude such that the vent guides 520 and 520′ deviate by one row in the row direction with respect to the left heat dissipation plate 300 illustrated in FIGS. 16 and 17.

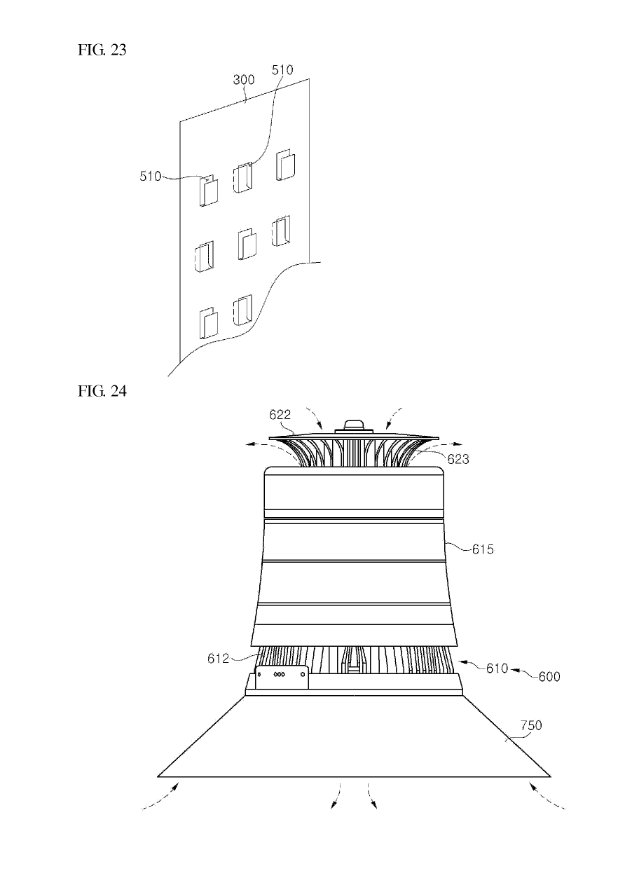

As for the arrangement structure of the vent guides 520 on the heat dissipation plate 300, a structure in which the vent cutout portion 530 and the vent guide 540 are omitted as illustrated in FIG. 22 can also be applied.

As for the arrangement structure of the vent guides 520 on the heat dissipation plate 300, a structure in which the vent guides 520 are disposed to protrude in different directions, respectively, to induce a more complicated turbulent flow can also be applied.

Meanwhile, the described-above heat sink including the heat dissipation plates according to various embodiments of the present invention can also be applied to lighting apparatuses according to embodiments of FIGS. 24 to 27.

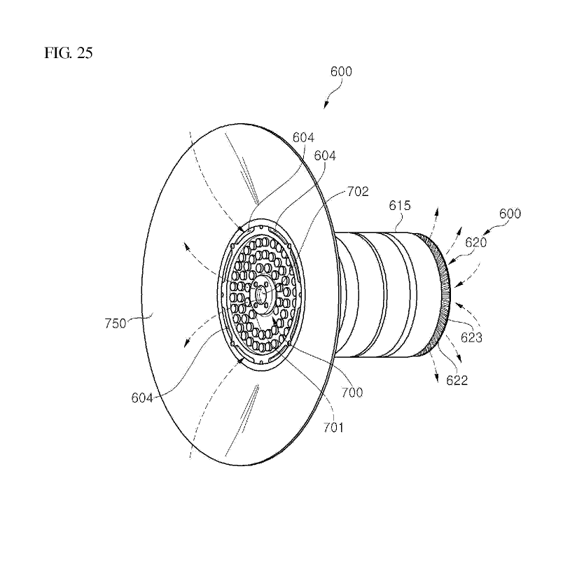

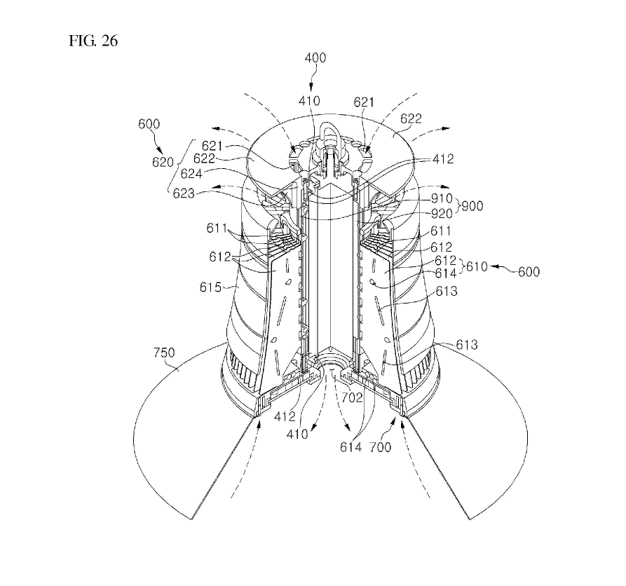

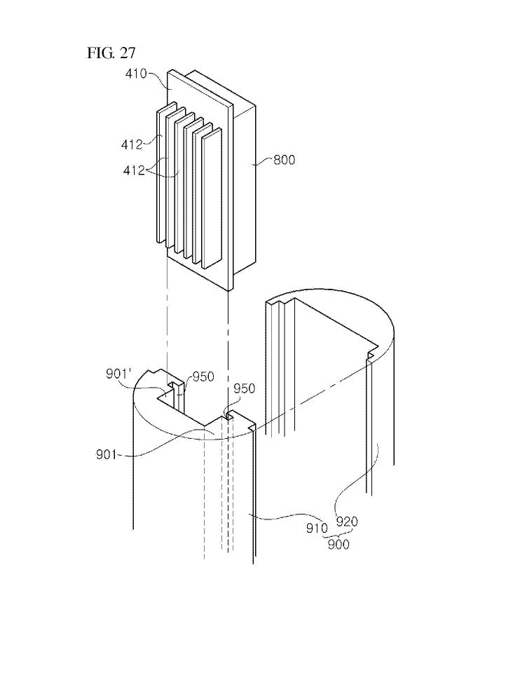

FIG. 24 is a lateral conceptual view illustrating an external appearance of the optical semiconductor lighting apparatus according to another embodiment of the present invention. FIG. 25 is a perspective view illustrating an external appearance of the optical semiconductor lighting apparatus according to another embodiment of the present invention. FIG. 26 is a partially cutaway perspective view illustrating an internal structure of illustrating the optical semiconductor lighting apparatus according to another embodiment of the present invention. FIG. 27 is a partial exploded perspective view illustrating a coupling relationship between a housing and a switching mode power supply (SMPS) as major parts of the optical semiconductor lighting apparatus according to another embodiment of the present invention.

As illustrated, an lighting apparatus includes a first heat dissipation unit 400 and a second heat dissipation unit 600 allowing a housing 900 having a power supply 800 (hereinafter, referred to as an ‘SMPS’) accommodated therein and a light emitting module 700 to communicate with each other internally and externally.

Reference numeral 750 in FIGS. 24 to 26 denotes a reflector.

For reference, the arrows indicated by dotted lines in FIGS. 24 to 26 denote air flow (or movement) direction, and an actual natural convection current may be generated in the mutually opposite directions along the area in which the first heat dissipation unit 400 is disposed and the area in which the second heat dissipation unit 600 is disposed.

However, in the embodiment of the present invention, for the description purpose, the curved dotted-line arrows are illustrated in the mutually opposite directions to check or recognize air flowing along the area in which the first heat dissipation unit 400 is disposed and the area in which the second heat dissipation unit 600 is disposed.

The light emitting module 700 includes one or more semiconductor optical devices 701 serving as a light source upon receiving power from the SMPS 800 connected to the light emitting module 700.

The housing 900 is formed in the light emitting module 700 and forms an internal space in which the SMPS 800 is accommodated.

The first heat dissipation unit 400 is formed from an inner side of one end portion of the housing 900 up to the light emitting module 700 to induce air flow (see the dotted-line arrow) through the interior of the housing 900 to promote a heat dissipation effect.

The second heat dissipation unit 600 is disposed radially in an outer side of the housing 900 and formed from an outer side of one end portion of the housing 900 up to the edge of the light emitting module 700 to induce air circulation (see the dotted-line arrow) through the exterior of the housing 900 to promote the heat dissipation effect together with the first heat dissipation unit 400.

Thus, the first heat dissipation unit 400 improves heat generation within the housing 900, and the second heat dissipation unit 600 improves heat generation of the light emitting module 700, and it can be seen that the first and second heat dissipation units 400 and 600 are disposed to discriminate regions for performing a cooling operation inside and outside of the lighting apparatus, that is, inside and outside of the housing 900.

In addition to the foregoing embodiment, the following various embodiments can also be applied.

Meanwhile, in order to form the air circulation path through the first heat dissipation unit 400 as described below, a vent hole 702 may be further provided at the center of the light emitting module 700 such that the vent hole 702 communicates with the interior of the housing 900.

The housing 900 may also serve as a heat insulating member preventing heat generated from the SMPS 800 from being transmitted to the outside.

The housing 900 may be divided into first and second members 910 and 920 for the convenience of overall checking, repairing, and assembling of the lighting apparatus (see FIG. 27).

That is, the first member 910 covers one side of the SMPS 800 in a length direction of the SMPS 800, and the second member 920 covers the outer side of the SMPS 800 in the length direction of the SMPS 800 and detachably coupled to the first member 910.

Meanwhile, as described above, the first heat dissipation unit 400 induces air circulation through the interior of the housing 900, and both edges of the first heat dissipation unit 400 are slidably coupled along an inner surface of the housing 900. The first heat dissipation unit 400 further includes a fixed panel 410 on which the SMPS 800 is disposed.

The SMPS 800 and the light emitting module 700 may be spaced apart from each other to enhance the heat dissipation effect and induce the air circulation.

In this case, in order to further increase the heat dissipation effect, the fixed panel 410 may include a plurality of heat dissipation fins 412 protruding from a surface opposed to the surface on which the SMPS 800 is disposed, in a direction in which the SMPS 800 is coupled.

Thus, referring to FIG. 26, a space between the mutually adjacent heat dissipation fins 412 may communicate with the light emitting module 700, specifically, up to the vent hole 702, and such a space may be utilized as a passage for air circulation.

Meanwhile, as described above, the second heat dissipation unit 600 serves to induce air circulation through the outside of the housing 900, and may include one or more vent slits 604 penetrating the edges of the light emitting module 700.

As illustrated in FIG. 25, a plurality of vent slits 604 may be disposed along the edges of the light emitting module 700.

Also, the second heat dissipation unit 600 may include a heat pipe assembly 610 disposed on an outer surface of the housing 900 and communicating with the light emitting module 700.

The heat pipe assembly 610 may include a plurality of heat dissipation thin plates 612 disposed radially on an outer surface of the housing 900 and a heat pipe 614 penetrating the respective heat dissipation thin plates 612 and forming an internal flow path.

A cover casing 615 with both ends opened may be disposed in an outer side of the heat dissipation thin plates 612 in order to protect the heat dissipation thin plates 612 against external physical or chemical impact.

The heat pipe assembly 610 may further include interval pieces 611 bent from an upper end portion or a lower end portion of the heat dissipation thin plates 612 and extending up to an upper end portion or a lower end portion of the heat dissipation thin plates 612 adjacent to the heat dissipation thin plates 612.

The lengths of the interval pieces 611 extending from the heat dissipation thin plates 612 are equal so that the plurality of heat dissipation thin plates 612 may be assembled while maintaining the equal and regular intervals.

As illustrated, one or more auxiliary vent slots 613 may be formed to penetrate each of the heat dissipation thin plates 612 to induce air circulation in a vertical direction through an outer side of the housing 900, and the auxiliary vent slots 613 may communicate with each other to induce a turbulent flow to further increase the heat dissipation effect.

Meanwhile, in order to smoothly discharge air to an upper side of the housing 900 or in order to allow air to be smoothly introduced from the upper side of the housing 900, the second heat dissipation unit 600 may include a top air guide 620 detachably coupled to an upper end portion of the housing 900 and communicating with the light emitting module 700.

Specifically, the top air guide 620 includes a cover piece 622 covering an upper end portion of the housing 900 and a coupling partition 624 extending from the cover piece 622 and disposed in contact with an outer surface of an upper end portion of the housing 900.

The top air guide 620 may further include a plurality of cover vent slits 621 penetrating the cover piece 622 such that the cover vent slits 621 correspond to an internal space formed by the coupling partition 624, thereby communicating even with the space between the heat dissipation fins 412 in the inner space of the first heat dissipation unit 400, that is, the housing 900.

In this case, in order to uniformly discharge air radially from the upper side of the housing 900 or in order to allow air to be uniformly introduced thereto, the top air guide 620 may further include a plurality of guide ribs 623 extending radially to a lower surface of the cover piece 622 along an outer surface of the coupling partition 624.

Also, in terms of air circulation, the arrangement position of the guide ribs 623 may correspond to the arrangement position of the heat dissipation thin plates 612 disposed radially in the immediately lower side.

Meanwhile, the optical semiconductor lighting apparatus according to the embodiment of the present invention further includes movement grooves 950 formed on surfaces 901 and 901′ facing each other in the inner side of the housing 900, respectively, to which both edges of the fixed panel 410 are coupled.

The first and second members 910 and 920 of the housing 900 may be detached or attached in the length direction of the SMPS 800.

Thus, in a state in which the first and second members 910 and 920 are coupled to each other, an operator may push the fixed panel 410 into the movement grooves 950 and slidably fasten the same to accommodate the SMPS 800 in the housing 900. Alternatively, the fixed panel 410 may be slidably fastened to one of the first and second members 910 and 920, specifically the first member 910 in FIG. 27, in advance, and the second member 920 may be coupled to the first member 910 to accommodate the SMPS 800 in the housing 900.

As described above, according to embodiments of the present invention, the optical semiconductor lighting apparatus can enhance heat dissipation efficiency by inducing a turbulent flow while extending air contact time, and can enhance heat dissipation effect by inducing air circulation inside and outside of the device can be provided.

In addition, a person skilled in the air can apply the housing 900 as a major part of the optical semiconductor lighting apparatus according to various embodiments of the present invention to factory light, working light, streetlamp, or the like, as illustrated in the drawings within the scope of the basic technical concept of the present invention.

The structure of the housing 900 can be divided into the detachable first and second members 910 and 920, and can be applied to cover a partition unit coupled to the SMPS 800 even to a lighting apparatus employing a fluorescent lamp type LED bar according to circumstances.

For example, the partition unit can be provided for the purpose of a heat dissipation function including the fixed panel 410 and the heat dissipation fins 412 as in the foregoing embodiments.

Also, although not particularly illustrated, the hosing can be modified and applied in various forms. That is, the housing may be wound several times together with the fixed panel 410 coupled to the SMPS 800 to cover the outer side of the SMPS 800 from the end portions of the heat dissipation fins 412 and applied in the form of an insulating film preventing heat transmission to the light emitting module 700.

According to the embodiments of the present invention as described above, the following advantages can be obtained.

First, by the vent portions according to various embodiments formed in a plurality of heat dissipation fins disposed in the heat pipe provided on the light emitting module, a heat transmission area can be increased to enhance heat dissipation performance. Also, by forming a circulation path of air alternately flowing on one surface and the other surface of each of the heat dissipation plates, air contact time is extended and a turbulent flow is induced, thereby further enhancing heat dissipation performance.

In particular, by forming the vent holes as one of elements constituting the vent portion on the heat dissipation plates, primary cooling can be performed through the heat pipe, and secondary cooling can be performed through the formation of the air circulation path through the vent holes.

In addition, ventilation through a natural convection current to the interior and exterior of the device is induced by the first heat dissipation unit allowing the interior of the housing, in which the SMPS is accommodated, and the light emitting module to communicate with each other, and the second heat dissipation unit allowing the exterior of the housing and the edges of the light emitting module to communicate with each other, thereby further enhancing heat dissipation efficiency.

While the embodiments of the present invention have been described with reference to the specific embodiments, it will be apparent to those skilled in the art that various changes and modifications may be made without departing from the spirit and scope of the invention as defined in the following claims.

What is claimed is:

1. An optical semiconductor lighting apparatus comprising:
a light emitting module including one or more semiconductor optical devices;
a switching mode power supply (SMPS) connected to the light emitting module;
a housing disposed to be adjacent to the light emitting module, wherein the housing has both ends opened and accommodates the SMPS;
a first heat dissipation unit disposed at an inner side of the housing; and
a second heat dissipation unit disposed radially at an outer side of the housing and formed from an outer side of one end portion of the housing to the edge of the light emitting module.

2. The optical semiconductor lighting apparatus of claim 1, further comprising a vent hole communicating with the interior of the housing at the center of the light emitting module.

3. The optical semiconductor lighting apparatus of claim 1, wherein the housing includes:
a first member covering one side of the SMPS in a length direction of the SMPS; and
a second member covering the other side of the SMPS in the length direction of the SMPS and detachably coupled to the first member.

4. The optical semiconductor lighting apparatus of claim 1, wherein the first heat dissipation unit further includes a fixed panel having both edges slidably coupled to an inner surface of the housing, the SMPS being disposed on the fixed panel, and the SMPS and the light emitting module are spaced apart from each other.

5. The optical semiconductor lighting apparatus of claim 3, wherein the housing further includes movement grooves formed on mutually facing surfaces in the interior of the housing, both edges of the fixed panel being coupled to the movement grooves, and the housing is attached or detached in the length direction of the SMPS.

6. The optical semiconductor lighting apparatus of claim 4, wherein the fixed panel further includes a plurality of heat dissipation fins protruding from a surface opposed to the surface on which the SMPS is disposed, in a direction in which the SMPS is coupled.

7. The optical semiconductor lighting apparatus of claim 6, wherein a space between the mutually adjacent heat dissipation fins communicates with the light emitting module.

8. The optical semiconductor lighting apparatus of claim 1, wherein the second heat dissipation unit includes one or more vent slits formed to penetrate an edge of the light emitting module.

9. The optical semiconductor lighting apparatus of claim 1, wherein the second heat dissipation unit includes a heat pipe assembly disposed on an outer surface of the housing and communicating with the light emitting module.

10. The optical semiconductor lighting apparatus of claim 1, wherein the second heat dissipation unit includes a top air guide detachably coupled to an upper end portion of the housing and communicating with the light emitting module.

11. The optical semiconductor lighting apparatus of claim 9, wherein the heat pipe assembly includes:
a plurality of heat dissipation thin plates disposed radially along the outer surface of the housing; and
a heat pipe penetrating the respective heat dissipation thin plates and forming an internal flow path.

12. The optical semiconductor lighting apparatus of claim 11, further comprising a cover casing disposed in the outer side of the heat dissipation thin plates and having both ends opened.

13. The optical semiconductor lighting apparatus of claim 11, wherein the heat pipe assembly further includes an interval piece bent from an upper or lower end portion of the heat dissipation thin plate and extending up to an upper or lower end portion of a heat dissipation thin plate adjacent to the heat dissipation thin plate.

14. The optical semiconductor lighting apparatus of claim 11, wherein the heat pipe assembly further includes one or more auxiliary vent slots penetrating the respective heat dissipation thin plates.

15. The optical semiconductor lighting apparatus of claim 10, wherein the top air guide includes:
a cover piece covering an upper end portion of the housing; and
a coupling partition extending from the cover piece and disposed in contact with an outer surface of an upper end portion of the housing.

16. The optical semiconductor lighting apparatus of claim 15, wherein the top air guide further includes a plurality of cover vent slits penetrating the cover piece such that the cover vent slits correspond to an inner space formed by the coupling partition.

17. The optical semiconductor lighting apparatus of claim 15, wherein the top air guide further includes a plurality of guide ribs extending radially to a lower surface of the cover piece along an outer surface of the coupling partition.

18. An optical semiconductor lighting apparatus comprising:
a light emitting module including one or more semiconductor optical devices;
a switching mode power supply (SMPS) connected to the light emitting module;
a housing disposed to be adjacent to the light emitting module and covering the SMPS;
a partition unit provided within the housing; and
an optical member corresponding to the semiconductor optical devices and facing the light emitting module.

19. The optical semiconductor lighting apparatus of claim 18, wherein the partition unit includes:
a fixed panel on which the SMPS is disposed; and
a plurality of heat dissipation fins protruding from a surface opposite to the surface on which the SMPS is disposed.

20. The optical semiconductor lighting apparatus of claim 18, wherein the housing includes:
a first member covering one side of the SMPS in a length direction of the SMPS; and
a second member detachably coupled to the first member and covering the heat dissipation unit coupled to the SMPS.

21. The optical semiconductor lighting apparatus of claim 18, wherein the partition unit is an insulating film wound several times along the outer surface of the SMPS.
